(19) United States
(12) Patent Application Publication
(10) Pub. No.: US 2014/0357291 A1
(43) Pub. Date: Dec. 4, 2014

(54) METHOD AND APPARATUS FOR SIGNAL-BASED POSITIONING

(71) Applicant: Nokia Corporation, Espoo (FI)

(72) Inventors: Jussi Artturi Leppanen, Tampere (FI); Antti Johannes Eronen, Tampere (FI)

(21) Appl. No.: 13/908,110

(22) Filed: Jun. 3, 2013

(51) Int. Cl. G01S 5/02; H04W 24/00

(52) U.S. Cl. CPC G01S 5/0278; H04W 24/00
USPC 455/456.1

(57) ABSTRACT

A method, apparatus, and computer program product are disclosed to normalize signal strengths and compensate for the variety of factors that may cause erroneous distance estimation, thereby increasing the accuracy of the distance estimation. In the context of a method, signal information is received relating to a signal transmitted by a first device and measured by a second device. Normalization information is accessed relating to the first device or the second device and normalized signal information is generated based on the signal information and the normalization information. A distance between the first device and the second device is estimated based on the normalized signal information. A corresponding apparatus and computer program product are also provided.

### TECHNOLOGICAL FIELD

Example embodiments of the present invention relate generally to signal-based positioning and, more particularly, to a method and apparatus for positioning in crowd-sourced video recording scenarios.

### BACKGROUND

When collecting crowd-sourced video recordings, it is desirable to obtain the positions of the users in the crowd, regardless of whether they are indoors or outdoors. In outdoor scenarios, positioning can be typically done using, for example, a global positioning system (GPS). However, in indoor scenarios, GPS may not work, so other positioning methods are required. Accordingly, (indoor or outdoor) positioning can be performed using, for example, radio signals (e.g., Bluetooth, wireless local area network (WLAN), etc.) emitted by the users' mobile devices. Unlike GPS positioning, however, these positioning systems are sensitive to differences in the mobile devices of the users.

For instance, there are differences in the radio signal strengths transmitted by different types of devices. Moreover, the orientation of a mobile device has an impact on the signal strengths transmitted in a particular direction or received from a particular direction since the reception and transmission of radio signals is performed with antennas with a varying amount of directivity (e.g., signal strength is greater in one direction than another direction). Furthermore, the mobile device can be situated in a user's pocket, purse, or bag, which may result in signal attenuation, thus adding noise to the measurements. In addition, walls, people and other obstructions may obstruct the signals, leading to erroneous distance estimation.

### BRIEF SUMMARY

Accordingly, a method, apparatus, and computer program product are provided to improve device positioning based on signal transmissions. In an example embodiment, a method, apparatus and computer program product are provided to normalize signal strengths and compensate for the variety of factors that may cause erroneous distance estimation, thereby increasing the accuracy of the distance estimation.

In a first example embodiment, a method is provided that includes receiving signal information relating to a signal transmitted by a first device and measured by a second device. The method includes accessing normalization information relating to the first device or the second device, and generating normalized signal information based on the signal information and the normalization information. The method further includes estimating, by a processor, a distance between the first device and the second device based on the normalized signal information.

In one embodiment, the method further includes determining that the first device and the second device are suitably situated for positioning, wherein the signal information is received after determining that the first device and the second device are suitably situated for positioning. In this embodiment, determining that the first device and the second device are suitably situated for positioning may include determining that the first device and the second device are recording video. In another embodiment, the normalization information may include a signal strength pattern of the first device, a type of the first device, an orientation of the first device, signal reception properties of the second device, a type of the second device, an orientation of the second device, or sensor data.

The method may further include determining estimated positions of the first device and the second device based on the estimated distance. In some embodiments, the positions of the first device and the second device are determined using multi-dimensional scaling. In this regard, the multi-dimensional scaling may comprise scaling by majorizing a complicated function. In other embodiments, the method may include repeating the generating of normalized signal information, the estimating of the distance between the first device and the second device, and the determining estimated positions of the first device and the second device, wherein the normalized signal information is updated based on the estimated positions of the first device and the second device.

In another example embodiment, an apparatus is provided having at least one processor and at least one memory including computer program code with the at least one memory and the computer program code configured to, with the at least one processor, cause the apparatus to receive signal information relating to a signal transmitted by a first device and measured by a second device. The at least one memory and the computer program code are further configured to, with the at least one processor, cause the apparatus to access normalization information relating to the first device or the second device, and generate normalized signal information based on the signal information and the normalization information. The at least one memory and the computer program code are further configured to, with the at least one processor, cause the apparatus to estimate a distance between the first device and the second device based on the normalized signal information.

In one embodiment, the at least one memory and the computer program code are further configured to, with the at least one processor, cause the apparatus to determine that the first device and the second device are suitably situated for positioning, wherein the signal information is received after determining that the first device and the second device are suitably situated for positioning. In this embodiment, determining that the first device and the second device are suitably situated for positioning may include determining that the first device and the second device are recording video. In another embodiment, the normalization information may include a signal strength pattern of the first device, a type of the first device, an orientation of the first device, signal reception properties of the second device, a type of the second device, an orientation of the second device, or sensor data.

The at least one memory and the computer program code are further configured to, with the at least one processor, cause the apparatus to determine estimated positions of the first device and the second device based on the estimated distance. In some embodiments, the positions of the first device and the second device are determined using multi-dimensional scaling. In this regard, the multi-dimensional scaling may comprise scaling by majorizing a complicated function. In other embodiments, the at least one memory and the computer program code are further configured to, with the at least one processor, cause the apparatus to repeat the generating of normalized signal information, the estimating of the distance between the first device and the second device, and the determining estimated positions of the first device and the second device, wherein the normalized signal information is updated based on the estimated positions of the first device and the second device.

In another example embodiment, a computer program product is provided that includes at least one non-transitory computer-readable storage medium having computer-executable program code portions stored therein with the computer-executable program code portions comprising program code instructions that, when executed, cause an apparatus to receive signal information relating to a signal transmitted by a first device and measured by a second device. The computer program code instructions, when executed, further cause the apparatus to access normalization information relating to the first device or the second device, and generate normalized signal information based on the signal information and the normalization information. The computer program code instructions, when executed, further cause the apparatus to estimate a distance between the first device and the second device based on the normalized signal information.

In one embodiment, the computer program code instructions, when executed, further cause the apparatus to determine that the first device and the second device are suitably situated for positioning, wherein the signal information is received after determining that the first device and the second device are suitably situated for positioning. In this embodiment, determining that the first device and the second device are suitably situated for positioning may include determining that the first device and the second device are recording video. In another embodiment, the normalization information may include a signal strength pattern of the first device, a type of the first device, an orientation of the first device, signal reception properties of the second device, a type of the second device, an orientation of the second device, or sensor data.

The computer program code instructions, when executed, may further cause the apparatus to determine estimated positions of the first device and the second device based on the estimated distance. In some embodiments, the positions of the first device and the second device are determined using multi-dimensional scaling. In this regard, the multi-dimensional scaling may comprise scaling by majorizing a complicated function. In other embodiments, the computer program code instructions, when executed, further cause the apparatus to repeat the generating of normalized signal information, the estimating of the distance between the first device and the second device, and the determining estimated positions of the first device and the second device, wherein the normalized signal information is updated based on the estimated positions of the first device and the second device.

In another example embodiment, an apparatus is provided that includes means for receiving signal information relating to a signal transmitted by a first device and measured by a second device. The apparatus includes means for accessing normalization information relating to the first device or the second device, and means for generating normalized signal information based on the signal information and the normalization information. The apparatus further includes means for estimating a distance between the first device and the second device based on the normalized signal information.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 shows a block diagram of an apparatus that may be specifically configured in accordance with an example embodiment of the present invention;

FIG. 2 illustrates a flowchart describing example operations for device positioning based on signal transmissions, in accordance with some example embodiments;

FIG. 3 illustrates a scenario in which mobile devices emit signals uniformly in all directions, in accordance with some example embodiments;

FIG. 4 illustrates a schematic diagram of a system for determining device positions, in accordance with some example embodiments;

FIG. 5 illustrates a scenario in which mobile devices emit signals non-uniformly, in accordance with some example embodiments;

FIG. 6 illustrates a schematic diagram of a system for determining device positions based on normalized signal information, in accordance with some example embodiments;

FIG. 7 illustrates a diagram including signal strengths transmitted from a reference device that emits signals uniformly in all directions, in accordance with some example embodiments;

FIG. 8 illustrates a diagram including signal strengths transmitted from a mobile device that emits signals uniformly in all directions at different strengths from a reference device, in accordance with some example embodiments;

FIG. 9 illustrates a diagram including signal strengths transmitted from a mobile device that emits signals non-uniformly, in accordance with some example embodiments;

FIG. 10 illustrates a more detailed diagram including signal strengths transmitted from a mobile device that emits signals non-uniformly, in accordance with some example embodiments;

FIG. 11 illustrates a flowchart describing example operations for improved device positioning based on signal transmissions, in accordance with some example embodiments; and

FIG. 12 illustrates a flowchart describing example operations for determining the absolute orientation of devices, in accordance with some example embodiments.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention.

Additionally, as used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus, and computer program product are provided in accordance with an example embodiment of the present invention in order to improve device positioning based on signal transmissions. In this regard, the method, apparatus, and computer program product may be embodied by any of a variety of devices. For example, the devices may include any of a variety of mobile terminals, such as a portable digital assistant (PDA), mobile telephone, smartphone, mobile television, gaming device, laptop computer, camera, tablet computer, video recorder, web camera, or any combination of the aforementioned devices. Additionally or alternatively, the method, apparatus, and computer program product of an example embodiment may be embodied by a networked device, such as a server or other network entity, configured to communicate with one or more devices, such as one or more client devices.

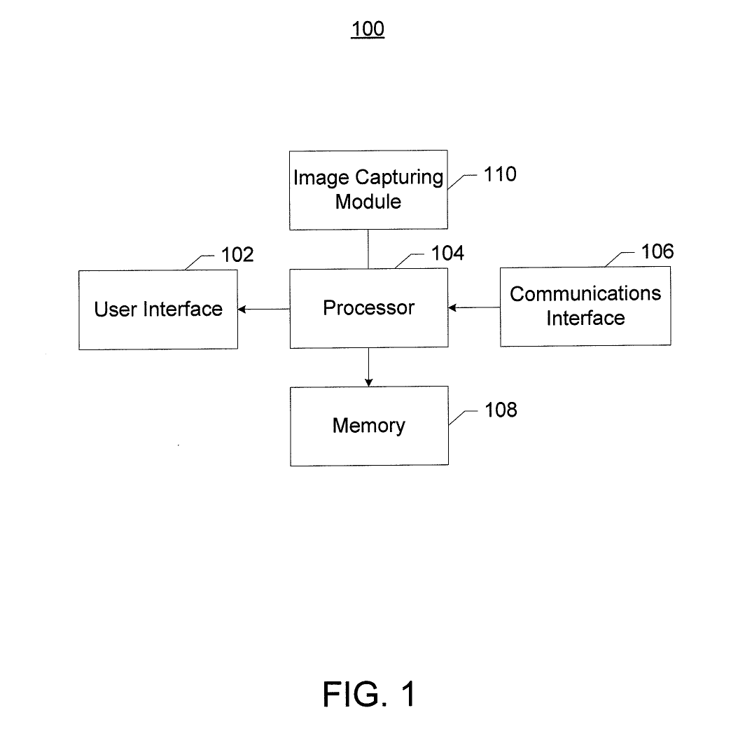

Regardless of the type of device, an apparatus 100 that may be specifically configured to improve device positioning based on signal transmissions in accordance with an example embodiment of the present invention is illustrated in FIG. 1. It should be noted that while FIG. 1 illustrates one example configuration, numerous other configurations may also be used to implement embodiments of the present invention. As such, in some embodiments, although elements are shown as being in communication with each other, hereinafter such elements should be considered to be capable of being embodied within the same device or within separate devices.

Referring now to FIG. 1, the apparatus 100 may include or otherwise be in communication with a processor 104, a memory device 108, and optionally a communication interface 106, a user interface 102, and/or an image capturing module 110. In some embodiments, the processor (and/or co-processor or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like, for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 100 may be embodied by a computing device, such as a computer terminal. However, in some embodiments, the apparatus may be embodied as a chip or chip set. In other words, the apparatus may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 104 may be embodied in a number of different ways. For example, the processor may be embodied as one or more of various hardware processing means such as a co-processor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

In an example embodiment, the processor 104 may be configured to execute instructions stored in the memory device 108 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

Meanwhile, the communication interface 106 may be any means such as a device or circuitry embodied in either hardware or a combination of hardware and software that is configured to receive and/or transmit data from/to a network and/or any other device or module in communication with the apparatus 100. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may additionally or alternatively support wired communication. As such, for example, the communication interface may include a communication modem and/or other hardware/software for supporting communication via cable, digital subscriber line (DSL), universal serial bus (USB), or other mechanisms.

In some embodiments, the apparatus 100 may include a user interface 102 that may, in turn, be in communication with processor 104 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone, and/or the like. The processor and/or user interface circuitry comprising the processor may be configured to control one or more functions of one or more user interface elements through computer program instructions (e.g., software and/or firmware) stored on a memory accessible to the processor (e.g., memory device 14, and/or the like).

As shown in FIG. 1, the apparatus 100 may also include an image capturing module 110, such as a camera, video and/or audio module, in communication with the processor 104. The image capturing element may be any means for capturing an image, video and/or audio for storage, display or transmission. As used herein, an image includes a still image as well as an image from a video recording. For example, in an example embodiment in which the image capturing element is a camera, the camera may include a digital camera capable of forming a digital image file from a captured image. As such, the camera may include all hardware (for example, a lens or other optical component(s), image sensor, image signal processor, and/or the like) and software necessary for creating a digital image file from a captured image. Alternatively, the camera may include only the hardware needed to view an image, while the memory 108 of the apparatus stores instructions for execution by the processor in the form of software necessary to create a digital image file from a captured image. In an example embodiment, the camera may further include a processing element such as a co-processor which assists the processor in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

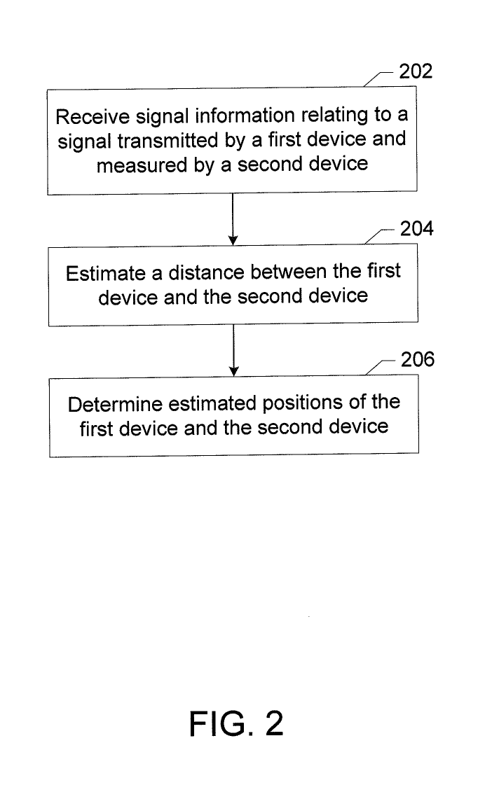

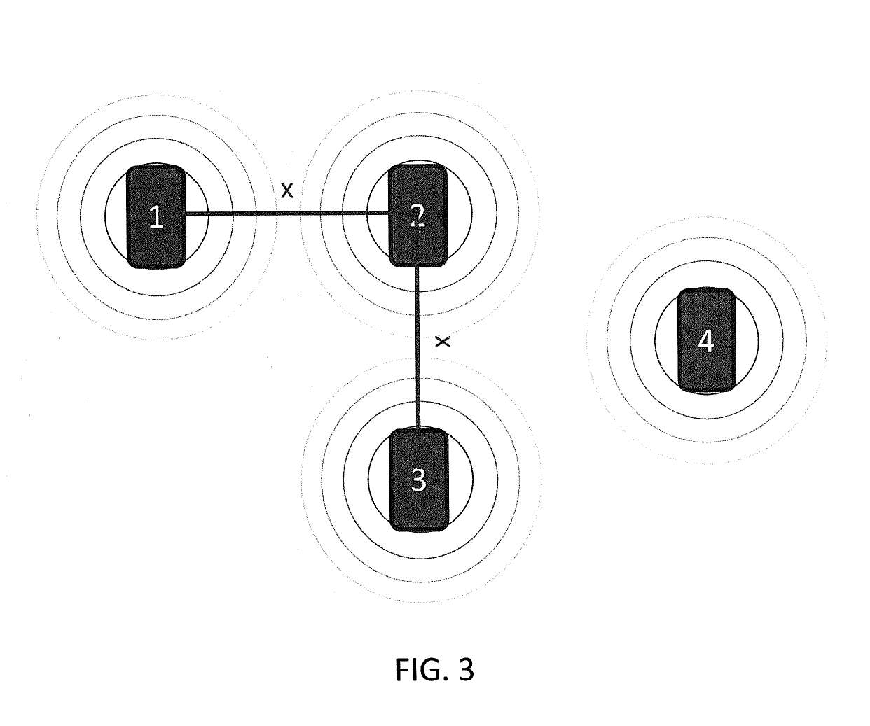

FIG. 2 illustrates a flowchart containing a series of operations performed to determine device positioning based on signal transmissions between mobile devices that emit signals uniformly in all directions. In this regard, FIG. 3 illustrates an example scenario illustrated which may employ such a signal-based positioning approach.

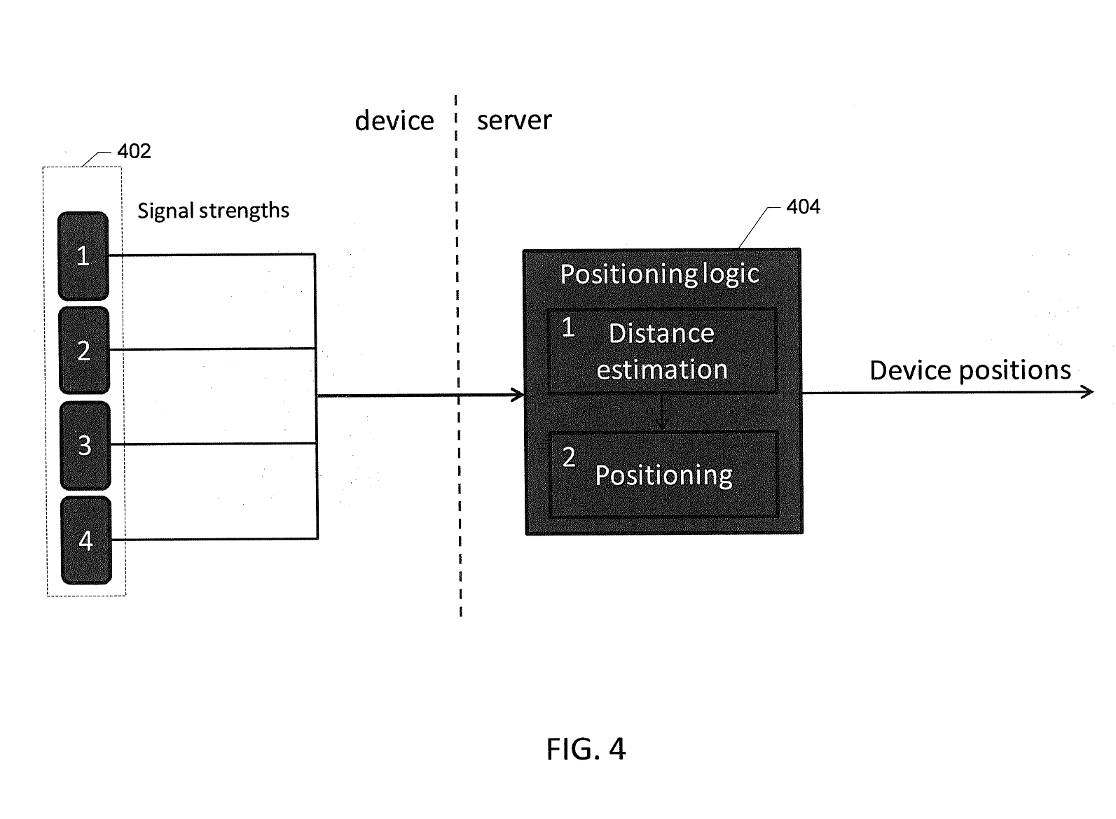

The operations illustrated in FIG. 2 may, for example, be performed by, with the assistance of, and/or under the control of one or more of processor 104, memory 108, user interface 102, or communications interface 106. In this regard, the operations may be performed by a mobile device, such as device “2” shown in FIG. 3, or by a separate device (e.g., a server, or the like) that receives signal information measured by the mobile device. When performed by a separate device, the operations may be implemented using a client/server approach, as shown in the schematic diagram illustrated in FIG. 4. In this regard, the mobile devices 402 transmit and receive signals and send the results to a server, which includes positioning logic 404 that estimates the distances between the devices, and calculates relative positions of the devices.

In operation 202 of FIG. 2, apparatus 100 includes means, such as user interface 102, communications interface 106, or the like, for receiving signal information relating to a signal transmitted by a first device and measured by a second device. In this regard, the signal transmitted may be a Bluetooth scan, WLAN signal, FM radio signal, or the like.

In operation 204, apparatus 100 includes means, such as processor 104, or the like, for estimating a distance between the first device and the second device. This distance estimation is performed based on the received signal information. For instance, each device may perform periodic Bluetooth scans which record the Bluetooth signal strengths of its surrounding devices. The Bluetooth addresses of the surrounding devices are also recorded. Based on the received signal information, the apparatus 100, such as the processor 104, of an example embodiment may then calculate the distance between two devices (A and B) by (assuming that both device A and device B have performed N Bluetooth scans each and sent the result to the server):
1) Finding the median (M_{A}) of the Bluetooth signal strengths of device B recorded by device A;
2) Finding the median (M_{B}) of the Bluetooth signal strengths of device A recorded by device B;
3) Calculating the average (M_{AB}) of M_{A} and M_{B};
4) Using the following formula to obtain a distance estimate (d_{AB}, in meters):

d_{AB}=10^{P}, where P=P₁M_{AB}+P₂
where P₁ and P₂ are pre-calculated constants (the determination of which is explained in the following paragraph); and
5) Repeating steps 1 to 4 for each pair of devices to obtain a matrix of distances D between each of the devices.

As mentioned above, apparatus 100, such as the processor 104, may use the formula: d_{AB}=10^{P}, where P=P₁M_{AB}+P₂ to obtain the distance between devices A and B.

To be able to use the formula the apparatus 100, such as the processor 104, defines P₁ and P₂ as follows (as an offline preprocessing step performed once after which the constants P₁ and P₂ are stored) by:
1) Recording Bluetooth signal strengths between the devices at different distances (in this regard, the concentric circles around each device in FIG. 3 illustrate the signal strengths of each device at different distances);
2) Finding the median signal strength for each of a set of distances (e.g., the median of signal strengths recorded at 1 meter distance, the median of signal strengths recorded at a 2 meter distance, etc.);
3) Plotting the (base-10) logarithm of the median signal strengths vs. the distances;
4) Fitting a line through the plot (for example, using the least squares fit) wherein the function that defines the line through the plot is of the form y=P₁x+P₂, where y corresponds to distances and x to the median signal strengths; and
5) Using the obtained values P₁ and P₂ for the above-described distance estimation. It is noted that other than first order polynomials could be used as well, such as second or third order polynomials.

Returning now to FIG. 2, in operation 206 apparatus 100 includes means, such as user interface 102, processor 104, the communications interface 106, or the like, for determining estimated positions of the first device and the second device. In one embodiment, the relative positions between the devices may be calculated using Multidimensional Scaling (MDS), which is a technique often used in information visualization but also in positioning. MDS takes, as input, a matrix of item-item similarities, and then assigns a location to each item in N-dimensional space.

In some embodiments, the apparatus 100, such as the processor 104, implements MDS by scaling by majorizing a complicated function (SMACOF), a process which is further described in “Sensor Positioning in Wireless Ad-hoc Sensor Networks Using Multidimensional Scaling,” by Xiang Ji et al., and “Multi-Dimensional Scaling for Localization” by Traian E. Abrudan, both of which are incorporated herein by reference in their entirety. As input, the algorithm utilizes the distance matrix D calculated in the operation 204. In addition, to implement MDS, a matrix W of weights is generated, such as by the processor 104, the elements of which define how each of the distances in matrix D is weighted in the calculations. In the simplest case, the weights can be all set to 1. If any measurements are missing, the corresponding weights in matrix W may be set to zero. In addition, if there is not confidence in some of the distance estimates, this can be reflected in the weight matrix W. For example, if the signal strengths of device A, as recorded by device B, differ significantly from the signal strengths of device B, as recorded by device A, a lower weight may be used in conjunction with the distance estimate. As output, the MDS provides (relative) positions of the devices.

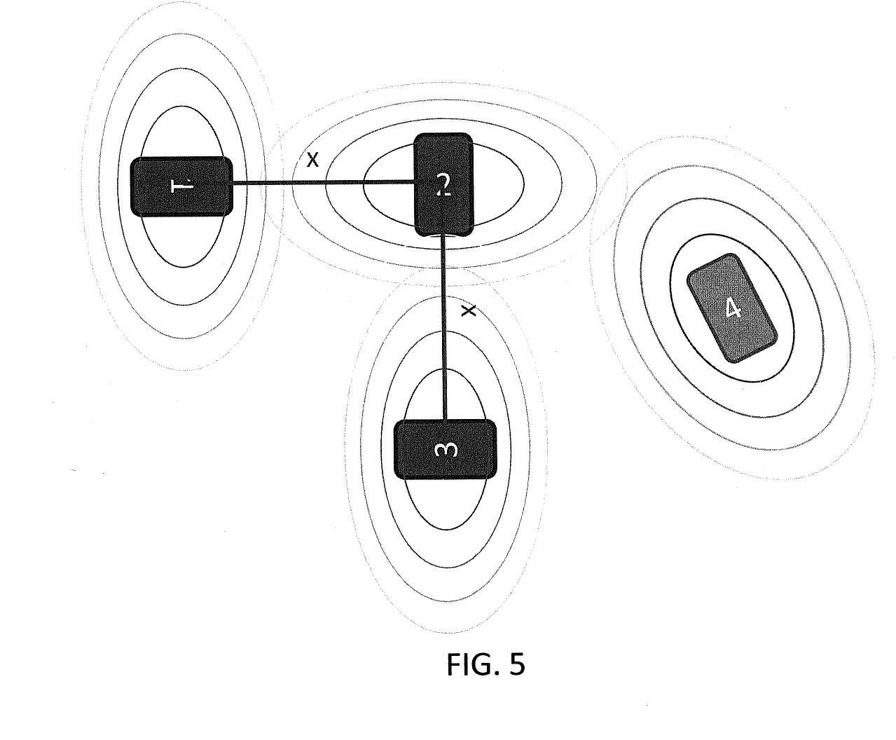

The operations described above in conjunction with FIG. 2 are effective assuming that each device emits Bluetooth signals uniformly in all directions. Moreover, this methodology assumes that each device to be used has identical Bluetooth signal transmission and reception properties. As previously noted, FIG. 3 illustrates these assumptions. However, in many situations, such conditions may not be present. In this regard, FIG. 5 illustrates a more common scenario, wherein the signal transmission strength of a mobile device is not uniform in all directions and is also not the same for every device.

For example, in FIG. 3, devices 1 and 3 are at an equal distance from device 2. In the example shown, the signal strength of device 1 and 3, as recorded by device 2, should be the same. It may often be the case however, that signal strength patterns are not uniform, and may be similar to those shown in FIG. 5, where, due to device orientation differences, the signal strength of device 3 is greater than the signal strength of device 1, when measured by device 2. Moreover, if some of the mobile devices are in their users' pockets or bags, the positioning results may be inaccurate due to signal attenuation caused by the pockets or bags.

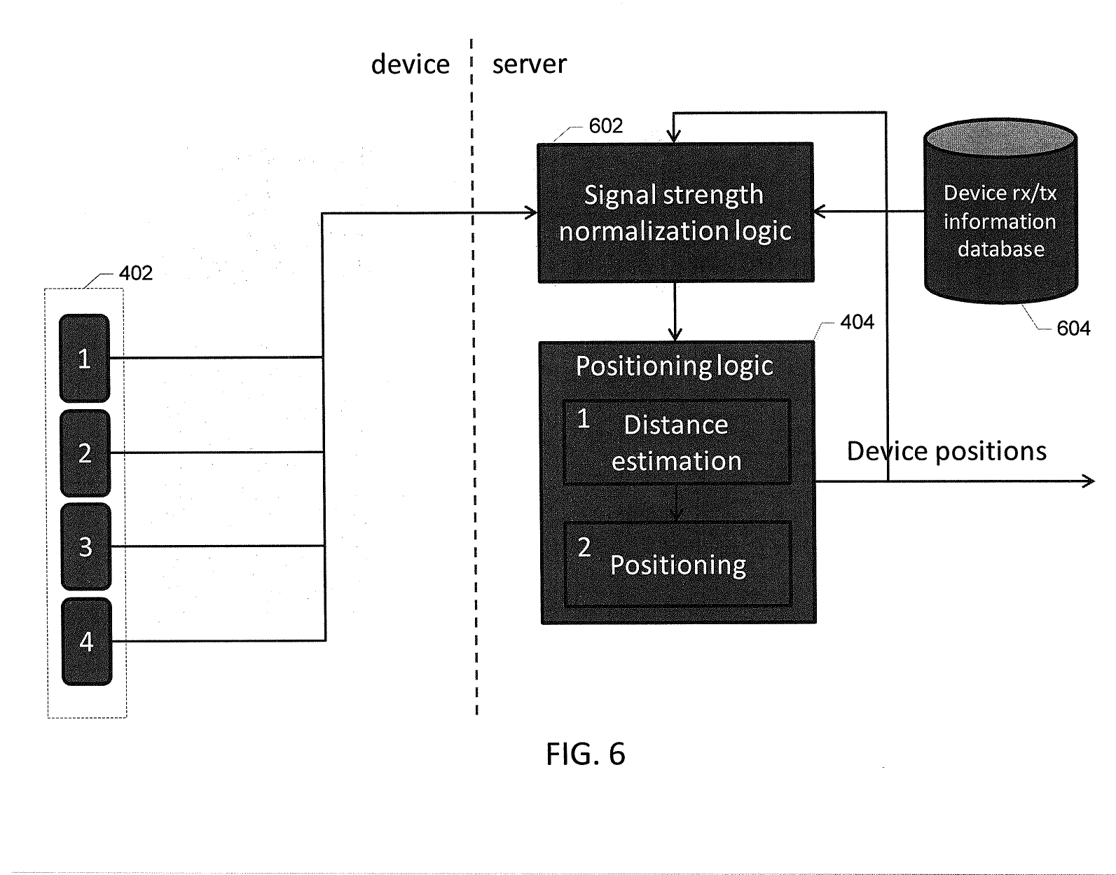

Turning now to FIG. 6, a schematic diagram is shown describing a system that compensates for the above signal irregularities and enables more accurate positioning in crowd-sourced video recording scenarios. The system may be implemented using a client/server approach, as shown in the schematic diagram illustrated in FIG. 6. In a similar fashion as illustrated in FIG. 4, the mobile devices 402 transmit and receive signals and optionally send the results to a server, which includes positioning logic 404 that estimates the distances between the devices, and calculates relative positions of the devices. In addition, however, the system, such as the processor 104, includes normalization logic 602 that compensates for signal irregularities using data taken from a device rx/tx information database 604. As with the system described by FIG. 4, the system shown in FIG. 6 may take the form of a client/server system, but the server elements 404, 602, and 604 may, in some embodiments, be housed within an individual mobile device, or stored, in a distributed manner, throughout the mobile devices in the crowd.

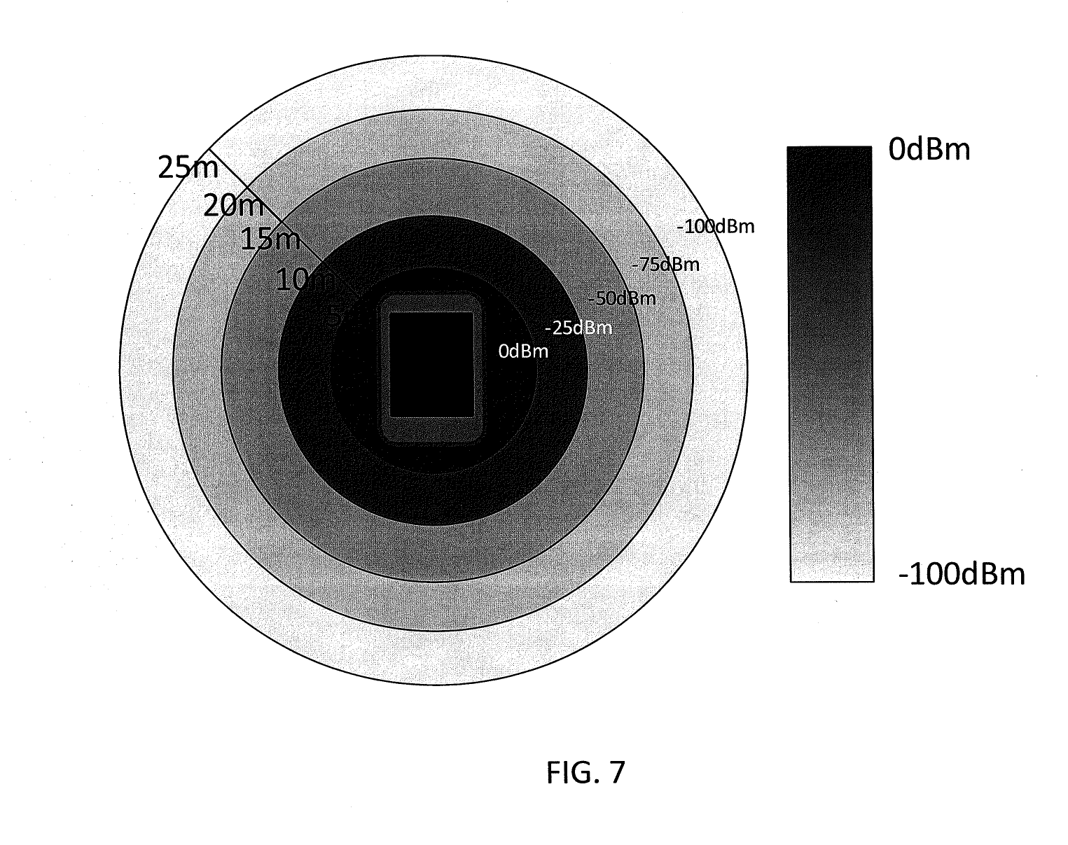

FIG. 7 illustrates a diagram including the signal strength of a reference device that emits signals uniformly in all directions. As noted previously, the methodology described with reference to FIG. 2 operates under the assumption that each of the devices involved in the positioning operations are modeled using such a reference device.

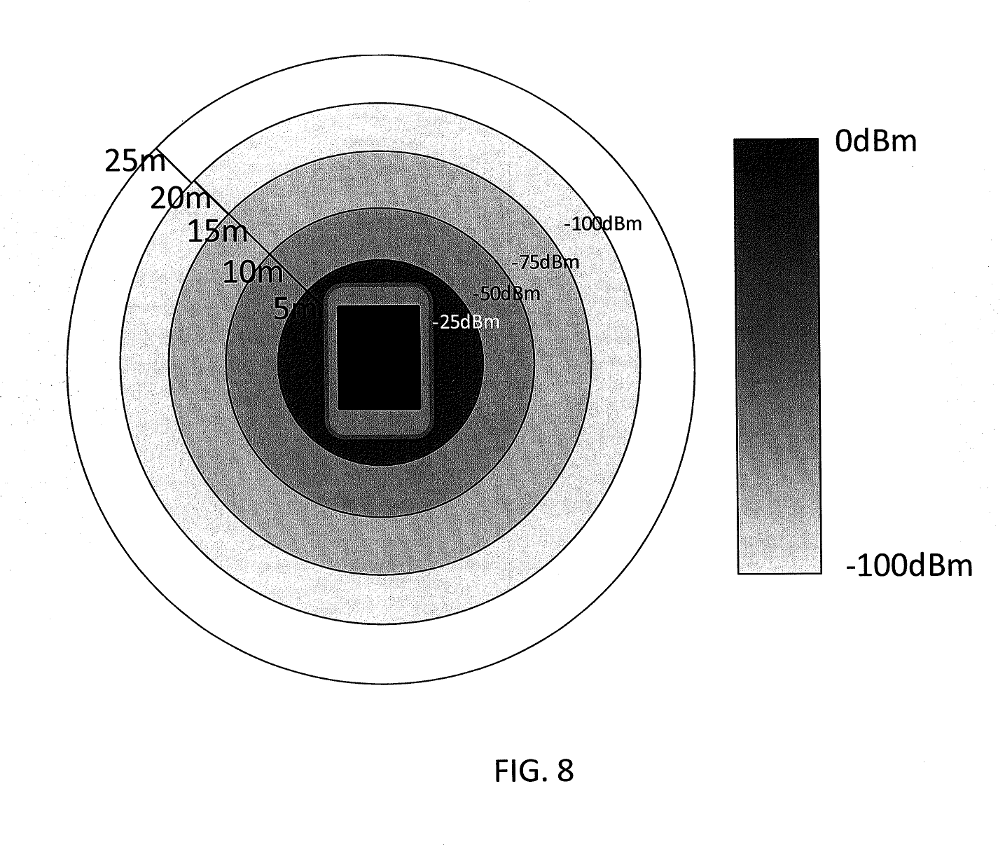

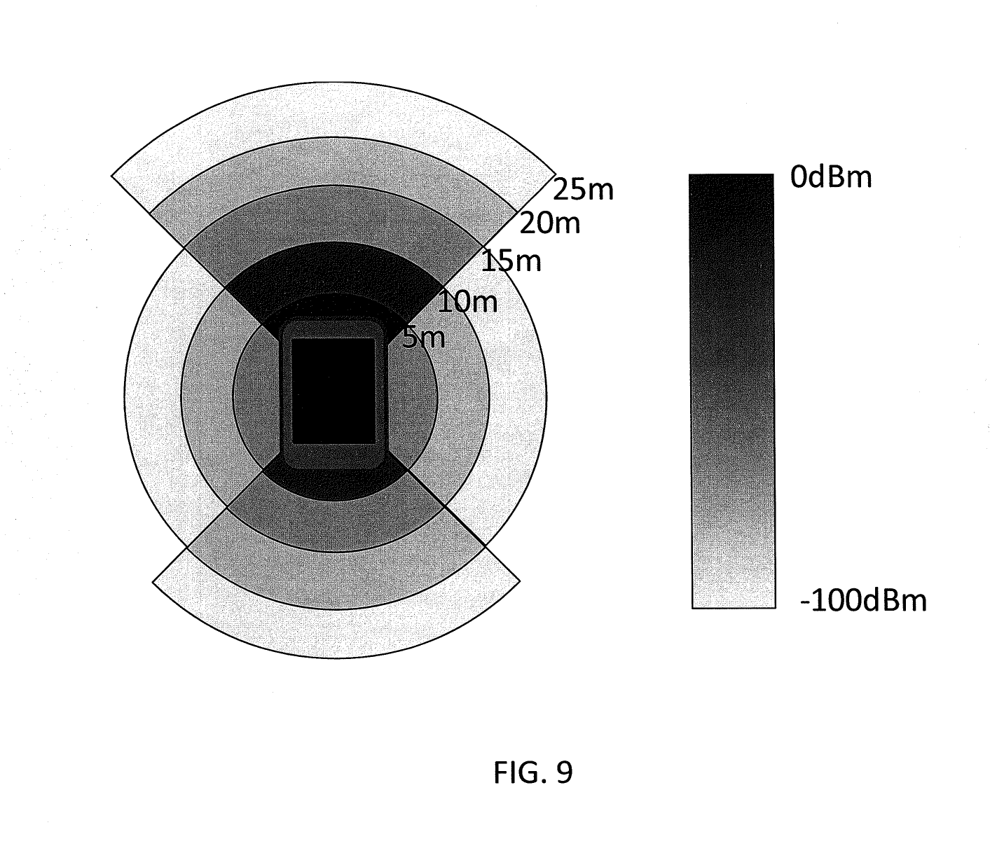

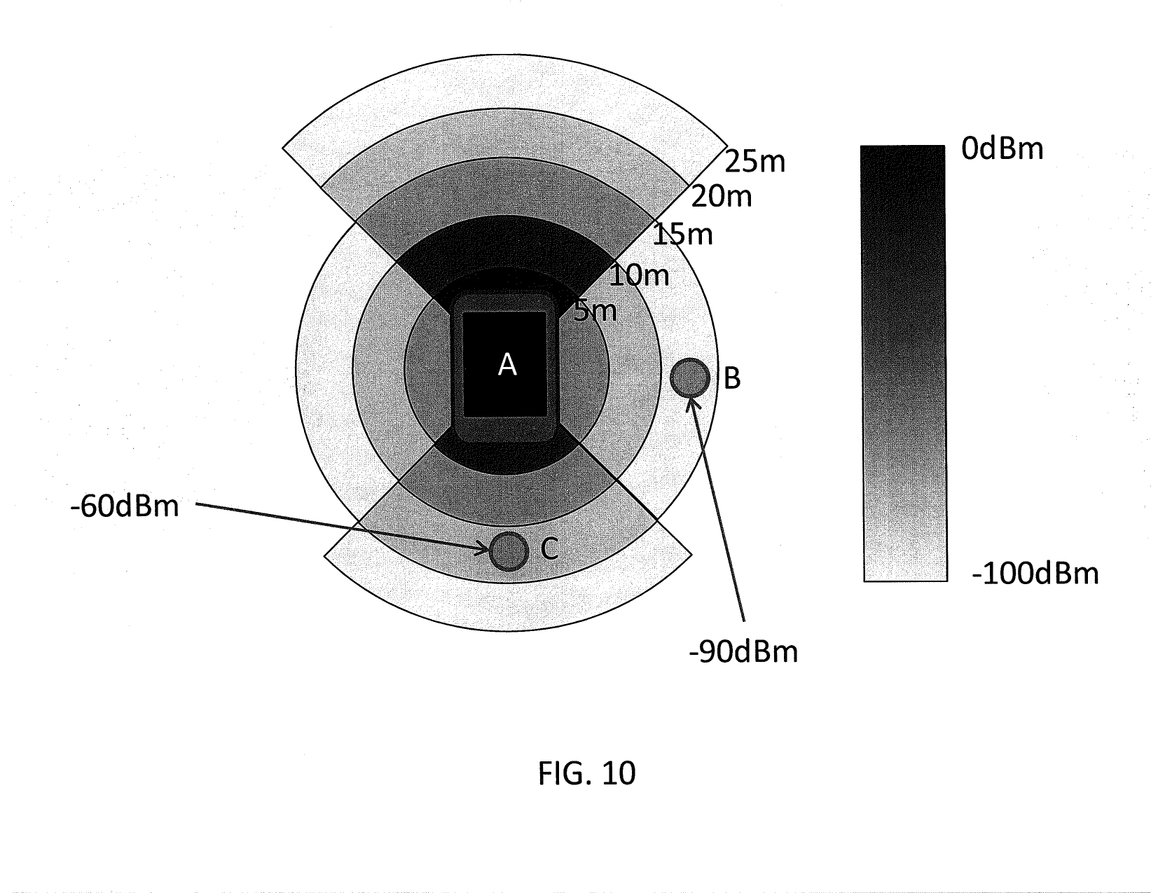

In contrast, FIGS. 8-10 illustrate diagrams of signal strength patterns transmitted from mobile devices that are not equivalent to the above-described reference device. In FIG. 8, the pattern emitted by the described mobile device emits signals uniformly in all directions, but those emissions are at different strengths from the reference device. In FIGS. 9 and 10, the pattern emitted by the mobile device emits signals non-uniformly. In this regard, FIG. 9 illustrates a diagram including signal strengths transmitted from a mobile device that emits signals non-uniformly, and FIG. 10 illustrates a more detailed diagram clearly showing that the signal strength at position B (−90 dBm) is different from the signal strength at position C (−60 dBm), even though points B and C are equidistant from device.

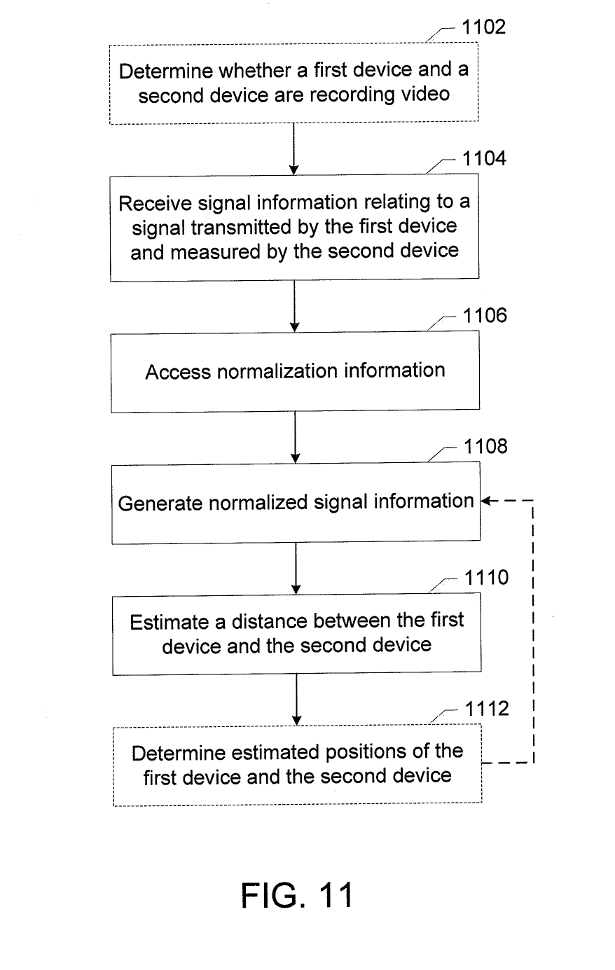

Turning now to FIG. 11, a flowchart is illustrated containing a series of operations performed to improve device positioning based on signal transmissions, using the system described above with reference to FIG. 6. The operations illustrated in FIG. 11 may, for example, be performed by, with the assistance of, and/or under the control of one or more of processor 104, memory 108, user interface 102, or communications interface 106. In this regard, the operations may be performed by an apparatus 100 embodied or otherwise associated with a mobile device or by a separate device (e.g., a server, or the like) in communication with a mobile device.

As previously described, if a device is stored (in a user's pocket or bag), there may be significant signal attenuation that could introduce error into a positioning determination. Accordingly, before performing positioning between two devices, a first pruning operation may be performed, based on the device context, to determine whether the device is suitably situated for positioning. The context, in this regard, refers primarily to whether a device is in the user's hand or in his pocket. However, without additional information, it may not be possible in every situation to determine whether the device is in a user's pocket.

One example heuristic for making this determination is to determine whether the device is currently recording or not recording video. For crowd-sourced content collection scenarios, it is only important to determine the positions of devices that are recording video. Thus, the devices which are not recording video are not considered for positioning. This allows for the positioning to be done only for devices which are not in the users' pockets and most likely being held at arm's length. For these devices, the radio signal strength is less affected by attenuations.

Another example heuristic for determining whether the device is outside the pocket is to utilize a proximity sensor to determine whether something is close to the sensor (such as a pocket) and/or performing a determination based on ambient light sensor readings to determine whether the device is in a dark place (possibly a pocket) or whether it can see light (more likely to be outside a pocket).

Another example heuristic of determining whether the device is situated suitably for positioning can be based on determining whether the device stationary or in motion. This can be done, for example, by analysing the accelerometer and/or Global Positioning System (GPS) data of the apparatus. That is, if the accelerometer signal does not indicate significant movement it is likely that the device is still. Correspondingly, if the GPS speed is zero or the location estimate from the GPS receiver is not changing the device may also be determined to still. In a yet another example, the device may be monitoring the signal strengths to one or more cellular base stations and, if the signal strengths are determined to be stable enough, it is likely that the device is static. Upon determining that the device is static or stationary, a plurality of Bluetooth scans can be performed to obtain more robust distance estimates.

Yet another example to determine whether the device is suitably situated for positioning includes determining the orientation of the device using accelerometer and/or compass and/or gyroscope data. That is, if the device is oriented display up or top side up, it is more likely that it is outside the pocket than when it is in a different orientation.

In yet another example, analysis of the accelerometer data and/or other sensor data is used to determine whether the device is likely held in a hand. An example includes comparing the accelerometer signal values (or features extracted from accelerometer signal values) to common accelerometer signal values (or features extracted from accelerometer signal values) often encountered when the device is held in hand, or using moisture sensors or other sensors to detect the likely proximity to a human hand.

Accordingly, in operation 1102, apparatus 100 may optionally include means, such as user interface 102, processor 104, the communications interface 106, or the like, for determining whether a first device and a second device are recording video.

In operation 1104, the apparatus 100 further includes means, such as processor 104 or the like, for receiving signal information relating to a signal transmitted by the first device and measured by the second device. Similarly to operation 202, the signal transmitted may be a Bluetooth scan, WLAN signal, FM radio signal, or the like.

In some embodiments, devices perform, for example, periodic Bluetooth signal scans, and, if arranged in a client/server system, send the scan results to the server. In one such embodiment, in addition to the Bluetooth scan information, the devices also send their orientation information (based on data retrieved from sensors, such as a compass, accelerometer, gyroscope, or the like) as well as the information on the type of device sending the information (e.g., the make and model of the mobile device).

Thereafter, in operation 1106, the apparatus 100 may include means, such as processor 104 or the like, for accessing normalization information. Some of this information may be stored in the device rx/tx information database 604, but some may also be included in the signal transmitted from the first device and measured by the second device. In addition, some of this information may be retrieved directly from the second device (e.g., the type of the second device, or sensor data from the second device). In any event, this normalization information may include a signal strength pattern of the first device, a type of the first device, an orientation of the first device, signal reception properties of the second device of the second device, a type of the second device, an orientation of the second device, or sensor data.

In operation 1108, the apparatus 100 may further include means, such as the processor 104 or the like, for generating normalized signal information based on the signal information and the normalization information. In this regard, the Bluetooth scan data is received by the signal strength normalization logic 602 implemented, for example, by the processor 104 of apparatus 100 which adjusts the signal strength readings such that they match those of a reference device, such as that described with reference to FIG. 7. For example, assume that device 4 from FIG. 5 emits Bluetooth signal at strength 10 dB higher than the reference device of FIG. 7. Using the operations described in FIG. 2, the signal strength of device 4, as measured by the other devices (1-3), will consistently be 10 dB too high, because device 4 is assumed to have a signal strength pattern of a reference device. Accordingly, to normalize the signal information, the normalized signal information relating to a signal transmitted from device 4 should have 10 dB subtracted. To implement the normalization, the signal strength patterns (e.g., parameters of the Bluetooth ratios) of the different devices are stored in the device rx/tx information database 604, after having been measured beforehand. In one embodiment, however, the data stored in the device rx/tx information database 604 could be the difference (in dB and in all directions) between the signal strength transmitted by the device compared to the signal strength transmitted by a reference device. Regardless, the normalized signal information is then passed to the positioning logic 404 implemented, for example, by the processor 104. Although discussed in conjunction with signal transmission strength, signal reception properties of the second device, such as differences in Bluetooth signal reception properties from the reference device, may also be used to normalize signal information. Similarly, although described for example purposes using Bluetooth signals, the normalization can also be done for the differences in Bluetooth signal reception properties as well. Also any signal type (Bluetooth, WLAN, Frequency Modulation (FM) radio) that can be transmitted by devices can be used.

Note that device orientation is not yet taken into account, even though orientation could introduce error into the positioning, as described previously. This is because without any estimate of the device positions, it is not possible to determine the orientations of the devices with respect to each other.

In operation 1110, the apparatus 100 may include means, such as the processor 104 or the like, for estimating a distance between the first device and the second device. This operation is similar to operation 204, described previously.

Similarly, in operation 1112, the apparatus 100 may optionally include means, such as the processor 104, memory 108, or the like, for determining estimated positions of the first device and the second device. This operation is similar to operation 206, described previously.

The output of the positioning logic is an initial estimate of the positions of the devices. As noted previously, orientation information cannot be factored into the normalization process without an initial positioning estimate. Accordingly, operations 1108-1112 may be repeated with the benefit of the calculated initial estimate of the positions of the devices to develop better normalized signal information by the signal strength nonnalization logic 602. In other words, with the initial position available, the signal strength normalization logic can utilize the device orientation information to adjust the normalized signal strengths of the devices. In the case of FIG. 5, the logic would adjust the signal strengths of device 1 and 3 as recorded by device 2 such that they would be equal. The new signal strengths can then be fed to the positioning logic again.

Operations 1108-1112 may thereafter be repeated until the estimated positions of the devices do not change. The latest obtained positions would then be the output of this system.

The above examples use multi-dimensional scaling to perform positioning after distances between devices have been estimated. However, example embodiments of the present invention are contemplated to be used to improve any positioning algorithm that estimates distances based on signal strengths. Moreover, example embodiments of the present invention are contemplated for use with any application, not just positioning, where distance calculations are performed based on signal strength information, where normalized signal strength information can improve the distance calculation.

Moreover, positioning methods can be split into (at least) two different approaches, relative positioning and absolute positioning, both of which benefit from embodiments of the present invention. Relative positioning refers to the positions of the devices with respect to each other, but not the ‘real world.’ With relative positioning, the configuration (in space) of the devices is known, but the latitude/longitude information of the devices may not be known. In absolute positioning, however, the aim is to find the positions of the users with respect to the ‘real world’.

In some embodiments in which relative positioning information is sought, device orientation information may not be available to use for normalizing the signal information, because the direction the devices are pointing may not be determinable. In such cases, the signal strength normalization logic 602 assumes that the devices have uniform signal transmission in all directions. Accordingly, the differences between the transmitted signal strengths of different devices are still normalized.

In other relative positioning embodiments, it would still be useful to know absolute orientation information for the group of users whose relative positions have been obtained using the above method. For example, in cases where the users are attending a concert, it may be important to learn which devices are in front of a stage and which are behind the stage. The audio signal information received by each device can be used to aid this determination.

In general, audio levels are more greatly attenuated the farther a device is from an audio source. Moreover, high frequencies are attenuated more effectively in the air than low frequencies. In concerts, people far away often cannot hear frequencies above 10 kHz. Accordingly, in one embodiment, audio capture is started in the user terminals to obtain user orientation information, and may be received as part of the signal information in operation 1104. The audio level and/or audio spectrum information may be analyzed from the audio signal, which serve as clues to determining absolute device orientation and location. After the relative user positions are obtained, the apparatus 100 may determine that the users whose average audio level, measured from the device, is the highest are determined to be closest to the stage, and correspondingly those devices whose audio levels are the lowest are determined to be located farthest away from the stage.

In addition, the energy at frequencies above 10 kHz can be measured and a ratio of that energy to the energy below 10 kHz can be calculated. The devices having the lowest ratio are probably farthest away from the stage, and correspondingly the users where the ratio is high are closer to stage. This allows the method to obtain an absolute orientation of the users with respect to the event venue and/or the dominant sound source. Note that the value 10 kHz is used as an example, and other similar values can alternatively be used for the purpose of calculating the frequency ratios.

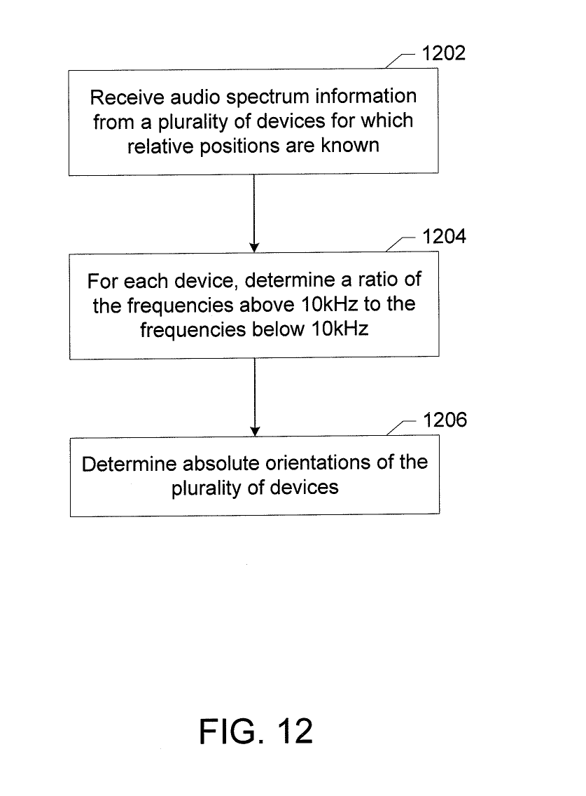

Turning now to FIG. 12, a flowchart is illustrated containing a series of operations to determine the absolute orientation of a group of devices using this technique. The operations may, for example, be performed by, with the assistance of, and/or under the control of one or more of processor 104, memory 108, user interface 102, or communications interface 106. In this regard, the operations may be performed by an apparatus 100 embodied or otherwise associated with a mobile device or by a separate device (e.g., a server, or the like) in communication with a mobile device.

In operation 1202, the apparatus 100 includes means, such as user interface 102, communications interface 106, or the like, for receiving audio spectrum information from a plurality of devices for which relative positions are known. In this regard, the audio spectrum information may be received as part of the signal information in operation 1104. In another embodiment, however, the audio spectrum information may be received as part of a separate operation from the positioning operations described above. In either embodiment, obtaining the audio spectrum information may involve computing a transform on an audio signal. In some embodiments, the transform may be the discrete Fourier transform or its derivative such as the Fast Fourier Transform. In some other embodiments, alternative transforms such as discrete cosine transforms, wavelets, filterbanks, mel-frequency cepstral coefficients, or modified discrete cosine transforms might be used.

In operation 1204, the apparatus 100 includes means, such as processor 104, or the like for determining, for each device, a ratio of the frequencies above 10 kHz to the frequencies below 10 kHz. Subsequently, in operation 1205, the apparatus 100 includes means, such as processor 103, or the like, for determining absolute orientations of the plurality of devices. The absolute orientation may be based on the ratio determined in operation 1204. The determination of the ratio of frequencies above 10 kHz to the frequencies below 10 kHz may involve, for example, calculating the average energy or power value above and below 10 kHz, and then calculating the ratio of these values. In some embodiments, instead of using the power or energy, the calculation may use the ratio of average spectral magnitude values.

As described above, FIGS. 2, 11, and 12 illustrate flowcharts of the operation of an apparatus, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 108 of an apparatus employing an embodiment of the present invention and executed by a processor 104 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which preform the specified functions, or combinations of special purpose hardware and computer instructions.

In some embodiments, certain ones of the operations above may be modified or further amplified. Furthermore, in some embodiments, the operations described using dashed lines may be optional, as shown, for example, in FIG. 11. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving signal information relating to a signal transmitted by a first device and measured by a second device;
accessing normalization information relating to the first device or the second device;
generating normalized signal information based on the signal information and the normalization information; and
estimating, by a processor, a distance between the first device and the second device based on the normalized signal information.

2. The method of claim 1, further comprising:
determining that the first device and the second device are suitably situated for positioning,
wherein the signal information is received after determining that the first device and the second device are available for positioning.

3. The method of claim 2, wherein determining that the first device and the second device are suitably situated for positioning comprises determining that the first device and the second device are recording video.

4. The method of claim 1, wherein the normalization information includes a signal strength pattern of the first device, a type of the first device, an orientation of the first device, signal reception properties of the second device, a type of the second device, an orientation of the second device, or sensor data.

5. The method of claim 1, further comprising:
determining estimated positions of the first device and the second device based on the estimated distance.

6. The method of claim 5, wherein the positions of the first device and the second device are determined using multi-dimensional scaling by majorizing a complicated function.

7. The method of claim 5, further comprising repeating the generating of normalized signal information, the estimating of the distance between the first device and the second device, and the determining estimated positions of the first device and the second device, wherein the normalized signal information is updated based on the estimated positions of the first device and the second device.

8. An apparatus comprising at least one processor and at least one memory including computer program code, the at least one memory and the computer program code configured to, with the at least one processor, cause the apparatus to:
receive signal information relating to a signal transmitted by a first device and measured by a second device;
access normalization information relating to the first device or the second device;
generate normalized signal information based on the signal information and the normalization information; and
estimate a distance between the first device and the second device based on the normalized signal information.

9. The apparatus of claim 8, wherein the at least one memory and the computer program code are further configured to, with the at least one processor, cause the apparatus to:
determine that the first device and the second device are suitably situated for positioning,
wherein the signal information is received after determining that the first device and the second device are suitably situated for positioning.

10. The apparatus of claim 9, wherein the at least one memory and the computer program code are configured to, with the at least one processor, cause the apparatus to determine that the first device and the second device are suitably situated for positioning by determining that the first device and the second device are recording video.

11. The apparatus of claim 8, wherein the normalization information includes a signal strength pattern of the first device, a type of the first device, an orientation of the first device, signal reception properties of the second device, a type of the second device, an orientation of the second device, or sensor data.

12. The apparatus of claim 8, wherein the at least one memory and the computer program code are further configured to, with the at least one processor, cause the apparatus to:
determine estimated positions of the first device and the second device based on the estimated distance.

13. The apparatus of claim 12, wherein the positions of the first device and the second device are determined using multi-dimensional scaling by majorizing a complicated function.

14. The apparatus of claim 12, wherein the at least one memory and the computer program code are further configured to, with the at least one processor, cause the apparatus to repeat the generating of normalized signal information, the estimating of the distance between the first device and the second device, and the determining estimated positions of the first device and the second device, wherein the normalized signal information is updated based on the estimated positions of the first device and the second device.

15. A computer program product comprising at least one non-transitory computer-readable storage medium having computer-executable program code portions stored therein, the computer-executable program code portions comprising program code instructions that, when executed, cause an apparatus to:
receive signal information relating to a signal transmitted by a first device and measured by a second device;
access normalization information relating to the first device or the second device;
generate normalized signal information based on the signal information and the normalization information; and
estimate a distance between the first device and the second device based on the normalized signal information.

16. The computer program product of claim 15, wherein the program code instructions, when executed, further cause the apparatus to:
determine that the first device and the second device are suitably situated for positioning,
wherein the signal information is received after determining that the first device and the second device are suitably situated for positioning.

17. The computer program product of claim 15, wherein the normalization information includes a signal strength pattern of the first device, a type of the first device, an orientation of the first device, signal reception properties of the second device, a type of the second device, an orientation of the second device, or sensor data.

18. The computer program product of claim 15, wherein the program code instructions, when executed, further cause the apparatus to:
determine estimated positions of the first device and the second device based on the estimated distance.

19. The computer program product of claim 18, wherein the positions of the first device and the second device are determined using multi-dimensional scaling by majorizing a complicated function.

20. The computer program product of claim 18, wherein the program code instructions, when executed, further cause the apparatus to repeat the generating of normalized signal information, the estimating of the distance between the first device and the second device, and the determining estimated positions of the first device and the second device, wherein the normalized signal information is updated based on the estimated positions of the first device and the second device.
